(19) United States
(12) Patent Application Publication
(10) Pub. No.: US 2002/0003455 A1
(43) Pub. Date: Jan. 10, 2002

(54) Broadband high frequency differential coupler

(76) Inventors: Gerd Vandersteen, Sint-Pieters-Leeuw (BE); Alain Barel, Schaarbeek (BE); Yves Rolain, Halle (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/821,818

(22) Filed: Mar. 29, 2001

Related U.S. Application Data
(60) Provisional application No. 60/193,592, filed on Mar. 30, 2000.

(51) Int. Cl. H01P 5/16

(52) U.S. Cl. 333/117; 333/26

(57) ABSTRACT

A broadband high frequency device is capable of determining linear combinations of broadband high frequent signals, in particular determining a differential signal, from input signals, being applied substantially simultaneously. One embodiment is based on a plurality of broadband microwave structures, arranged such that symmetry properties can be exploited. The output signal of this differential coupler is proportional to the difference of 2 input ports. This signal is made using a hybrid structure. A pair of broadband impedances are used to scale the 2 incoming signals with 2 complex coefficients. A symmetric structure of two identical broadband directional couplers and a symmetric power combiner are used afterwards to obtain the differential signal. The high bandwidth of both the terminations, the directional couplers and the power combiner make it possible to obtain a differential coupling factor and a common mode rejection ratio which is frequency insensitive over several decades.

### FIELD OF INVENTION

The invention relates to an apparatus and the method embedded therein for handling high frequent broadband signals.

### BACKGROUND

Analog integrated circuit designs are often differential in order to be less sensitive to common mode perturbations. The operational frequencies of the differential analog designs increases towards the microwave frequencies. The measurement of high frequent differential signals therefore becomes an important topic for measuring analog high frequent devices [D. E. Bockelman and W. R. Eisenstadt, “Combined Differential and Common-Mode Scattering Parameters: Theory and Simulation”, Trans. on Microwave Theory and Techniques, Vol. 43, No. 7, July 1995, pp. 1530-1539.], [D. E. Bockelman, W. R. Eisenstadt, “Pure-Mode Network Analyzer for On-Wafer Measurements of Mixed-Mode S-Parameters of Differential Circuits”, IEEE Trans. on Microwave Theory and Techniques, Vol 45, No. 7, July 1997, pp. 1071-1077.].

A schematic representation of a measurement setup, comprising couplers and a differential hybrid, is shown in FIG. 1. The couplers in the signal path are used to reduces the influence of the measurement setup upon the DUT (device under test, not shown). They also make it possible to perform e.g. load-pull measurements.

After these couplers, the differential signal needs to be made by making the difference of the 2 signals. Existing techniques and differential hybrids which perform such operation can be classified in the following categories:

High frequent transformers make it possible to transform the differential signals into a single ended one. This solution is broadband but is limited to frequencies up to several GHz. High frequency transformers—i.e. up to 50 GHz—are not realizable.

Network analysers which measure both incoming signals independently [D. E. Bockelman, W. R. Eisenstadt, “Pure Mode Network Analyzer for On-Wafer Measurements of Mixed-Mode S-Parameters of Differential Circuits”, IEEE Trans. on Microwave Theory and Techniques, Vol 45, No. 7, July 1997, pp. 1071-1077.]. This might results in a loss in dynamic range if one has to subtract two almost identical signals. Hence, large common mode signals considerably reduce the dynamic range of the analyser.

Several differential to single ended hybrid structures are available at microwave frequencies. These so called baluns basically splits up a singled ended signal into a differential signal. They are operational for a frequency band which is in the order of magnitude of 1 decade. They are designed to have negligible loss when converting from a single ended signal into a differential signal (or back). A Marchand balun [T. Chen, K. W. Chang S. B. Bui, H. Wang, “Broadband Monolithic Passive Baluns and Monolithic Double-Balanced Mixer”, IEEE Trans. on Microwave Theory and Techniques, Vol. 39, No. 12, December 1991, pp. 1980-1986.], [R. Schwindt and C. Nguyen, “Computer-Aided Analysis and Design of a Planar Multilayer Marchand Balun”, IEEE Trans. on Microwave Theory and Techniques, Vol. 42, No. 7, July 1994, pp. 1429-1434.], shown in FIG. 18, is often used in practice. FIG. 18 clearly shows that a Marchand balun is build around coupled lines without any resistors—or 3 dB couplers (e.g. Lange couplers [J. Rogers, B. Bhatia, “A 6 to 20 GHz Planar Balun Using a Wilkinson Divider and Lange Couplers”, 1991 MTT-S International Microwave Symposium Digest 91.2, pp. 865-868.]). The lack of resistive components makes that a Marchand balun has low losses. Its is also the lack of absorbing components which makes these devices frequency dependent. The balun is constructed such that around the operational frequency one has a balance between different contributions of the set of coupled lines. The delay introduced by the couplers therefore determines the operational frequency. Hence, the Marchand balun is—even when considering ideal couplers—a frequency dependent design. Other balun stuctures have been published in the literature [T. Chen, K. W. Chang S. B. Bui, H. Wang, “Broadband Monolithic Passive Baluns and Monolithic Double-Balanced Mixer”, IEEE Trans. on Microwave Theory and Techniques, Vol. 39, No. 12, December 1991, pp. 1980-1986.], [R. Schwindt and C. Nguyen, “Computer-Aided Analysis and Design of a Planar Multilayer Marchand Balun”, IEEE Trans. on Microwave Theory and Techniques, Vol. 42, No. 7, July 1994, pp. 1429-1434.], [E. M. T Jones, J. K. Shimizu, “A Wide-Band Strip-Line Balun”. IRE Trans. on Microwave Theory and Techniques, January 1959, pp. 128-135.], [B. J. Minnis, M. Healy, “New Broadband Balun Structures for Monolithic Microwave Integrated Circuits”, 1991 MTT-S International Microwave Symposium Digest 91.2, pp. 425-428.]. The isolated ports of the couplers (or coupled lines) are terminated by a short circuit or an open circuit (see FIGS. 19 and 20). The lack of absorbing devies ar the the isolated ports of the couplers makes that the structures depend one the frequency of operation. Hence, even with ideal couplers, a frequency dependent behaviour is expected. Absorbers in balun structures are only found in some rare occasions [S. Walker, “Broadband Stripline Balun using Quadrature Couplers”, IEEE Trans. on Microwave Theory and Techniques, February 1968, pp. 132-133.]. The structure of this balun is represented in FIG. 22. The asymmetry of the structure and the use of the open circuits at both points D and E makes this balun frequency dependent once more.

Lange couplers and Marchand baluns are narrowband (less than 1 decade in frequency range). It is, however, possible to design and realize broadband directional couplers [R. Levy, “General Synthesis of Asymmetric Multi-Element Coupled Transmission-Line Directional Couplers”, IEEE Trans. on Microwave Theory and Techniques, July 1963, pp. 226-237.] and microwave bridges [B. S. Donecker, J. K. Botka, Hewlett Packard Co. (US), U.S. Pat. No. 4,588,970, “Three section termination for an R. F. triaxial directional bridge”.] which cover a frequency band of at least 2 decades above 50 MHz. Note that microwave bridges often use a (narrowband) balun internally. Reference [B. S. Donecker, J. K. Botka, Hewlett Packard Co. (US), U.S. Pat. No. 4,588,970, “Three section termination for an R. F. triaxial directional bridge”.] describes a broadband microwave bridge which replaces the balun by a distributed load.

### SUMMARY

In one aspect of the invention an apparatus for handling high frequent signals is presented. More in particular said apparatus is particularly suited for determining a differential signal of a first and a second signal. Said signals are characterized as having high frequency components. Further said signals are characterized as having a broad frequency range of at least two decades or even three decades.

In a first aspect of the invention an apparatus is disclosed comprising a 5-port circuit. Two of said ports receive the signals from which a differential signal must be determined. Said received signals are thus input signals. The associated ports are thus input ports. Said differential signal is an output signal, delivered at the output port of said 5-port circuit. Further said apparatus comprises of two impedances, being connected to the remaining two ports. Said impedances are characterized in that they have a reflection factor with an opposite sign. Alternatively it can be stated that said impedances are asymmetric with respect to each other when considering a Smith Chart representation. The 5-port circuit is considered to be symmetric, meaning that when reversing both inputs and both impedances, results in identically the same behaviour of said 5-port circuit.

In a second aspect of the invention an apparatus is disclosed comprising of two directional coupler, a power combiner and again two asymmetric impedances. These directional couplers can also be substituted by microwave bridges. Said directional couplers are characterized by the relations between their ports. The input port, also denoted first port, couples a part of the input signal to a fourth port. Said fourth port is matched to an absorber, such that a substantial part of said coupler signal is dissipated. The second port of said coupler is connected to one of said impedances, and reflects internally in said directional coupler a signal. Said reflected signal is coupled to said third port, which thus transmits a signal being at least proportional with said reflected signal. In an embodiment of the invention said directional couplers are 4-port directional couplers and said power combiner is a 3-port power combiner. In a further embodiment one of said impedances is a short-circuit while the other impedance is then an open end.

In a third aspect of the invention a multiple input, multiple output apparatus is disclosed, being capable of handling high frequent broadband signals. Said outputs of said apparatus are linear combinations of said input signals, with reel proportionality constants. The apparatus is characterized in that said proportionality constant are frequency independent. The apparatus comprises of a plurality of directional couplers and power combiners, for combining said directional couplers and impedances, selected such that the appropriate reel proportionality constants are realized.

In a fourth aspect of the invention the method of generating a differential signal from two input signals and in general the method of generating linear combinations of signals, both methods suited for high frequent broadband signals is disclosed. The method is characterized in that signals, determined by a frequency independent reflection, generating reflected signals, are combined, while said signals are physically decoupled from the input signals and said reflected signals and said combined signals are substantially only electromagnetically coupled to said reflected signals.

Said apparatus and methods according to any of the four aspects is adapted for or suited for handling high frequency signals, meaning is performing its normal defined operation for such high frequent signals. More in particular some embodiments of said apparatus are suited for dealing with signals having frequencies above 1 GHz, other embodiments can handle frequenties above 5 GHz, still other embodiments can deal with frequenties above 10 GHz. Other embodiments can go above 100 GHz or even above 110 Ghz.

Said apparatus and methods according to any of the four aspects is designed such that the two high frequency signals handled are applied substantially simultaneously on the respective inputs of the device in order to avoid measure and store operations, leading to loss of dynamic range.

Said apparatus and methods according to any of the four aspects is adapted for or suited for handling frequency signals having a frequency spectrum beyond one decade. With one decade is meant 1-10 MHz or 10-100 MHz or 100 MHz-1 GHz or 1 GHz-10 GHz. Having a frequency spectrum beyond one decade, means that said signal has in a substantial way frequency components within at least to two subsequent decades, for instance 1-10 MHz and 10-100 MHz or instance 10-100 MHz and 100 MHz-1 GHz and so one. Some embodiments of said apparatus can handle spectra beyond two decades, meaning at least three decades. Alternatively one can state that a two decade spectrum is covered when the ratio of the maximum frequency to the minimum frequency is larger than 10. A three decade spectrum has a ratio larger than 100.

Some embodiments of the invented apparatus deals with signals with a frequency spectrum between 10 MHz and 10 Ghz, hence three decades and dealing with high frequency signals above 5 Ghz.

In an embodiment of the invention said apparatus uses broadband differential couplers, covering a frequency band of at least 2 decades.

In an embodiment of the invention said apparatus uses high frequent differential couplers, capable of handling signals with frequencies above 5 Ghz.

In an embodiment of the invention said apparatus uses high frequent broadband differential coupler, handling spectra of at least 2 decades having frequenties above 5 Ghz.

### DESCRIPTIONS OF THE DRAWING

FIG. 1. Structure of the differential coupler.

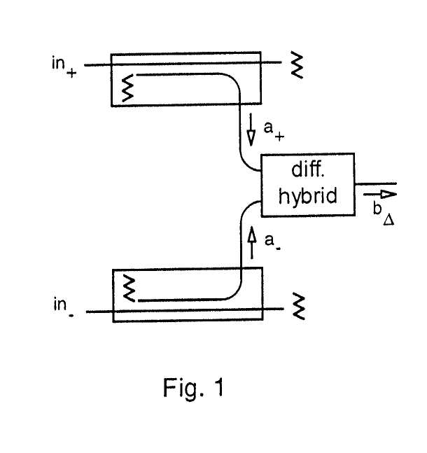

FIG. 2 The differential hybrid apparatus according to the invention, comprising of two anti-symmetric impedances (10), (20) and a 5-port circuit (30).

FIG. 3. Port numbering of the directional coupler and the power combiner.

FIG. 4 The generalized hybrid apparatus according to the invention.

FIG. 5. Differential hybrid structure composed out of 3 coupled thick rectangular bars.

FIG. 6. Coupling factor of the microwave bridges.

FIG. 7. Directivity of the microwave bridges.

FIG. 8. Differential coupling factor of the differential hybrid structure.

FIG. 9. CMRR of the differential hybrid structure.

FIG. 10. Amplitude ratio of the transfer functions from the inputs to the output.

FIG. 11. Phase difference of the transfer functions from the inputs to the output

FIG. 12. Coupling factor of the 45 MHz-50 GHz directional couplers.

FIG. 13. Directivity of the 45 MHz-50 GHz directional couplers.

FIG. 14. Differential coupling factor of the 50 GHz differential hybrid structure.

FIG. 15. CMRR of the 50 GHz differential hybrid structure.

FIG. 16. Amplitude ratio for the 50 GHz hybrid of the transfer functions from the inputs to the output.

FIG. 17. Phase difference for the 50 GHz hybrid of the transfer functions from the inputs to the output.

FIG. 18. Schematic representation of a Marchand balun.

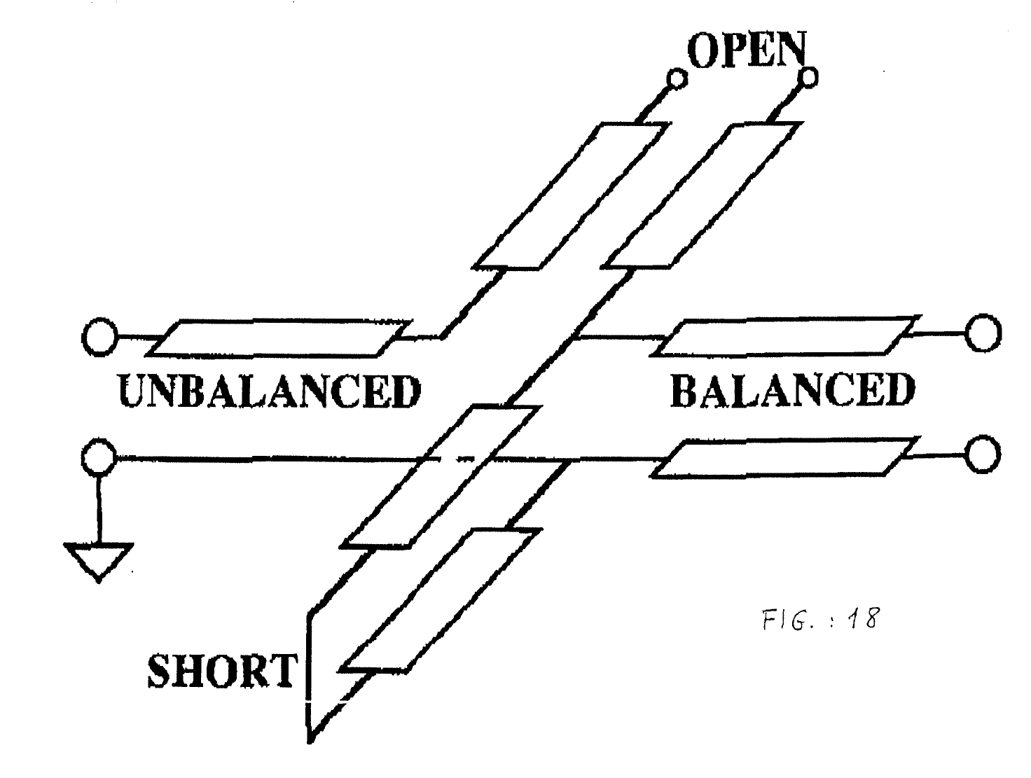

FIG. 19. The coupled lines are terminate using either short circuits or open circuits.

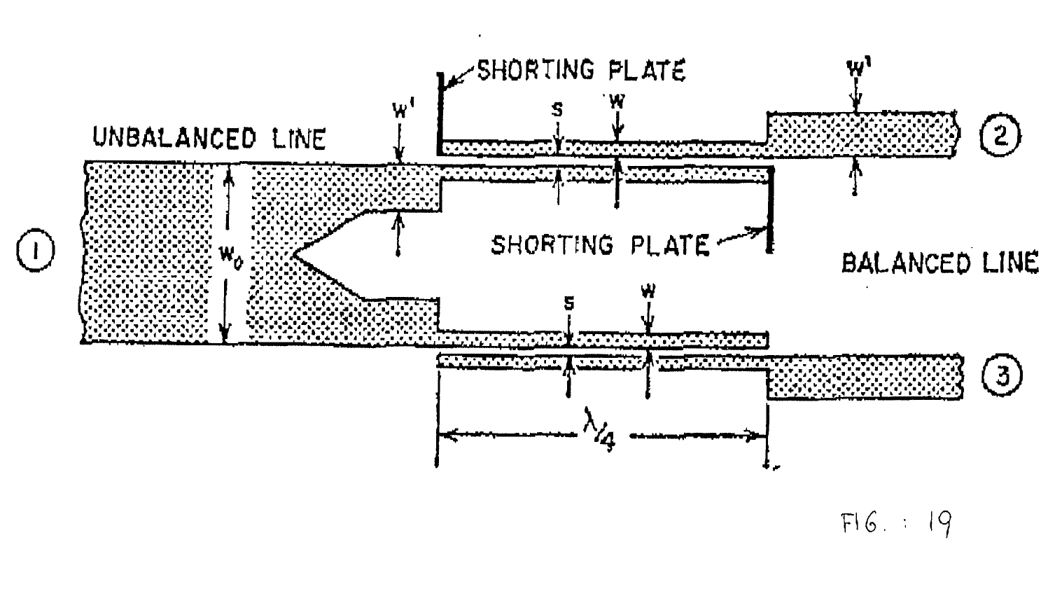

FIG. 20. The coupled lines are terminate using either short circuits or open circuits.

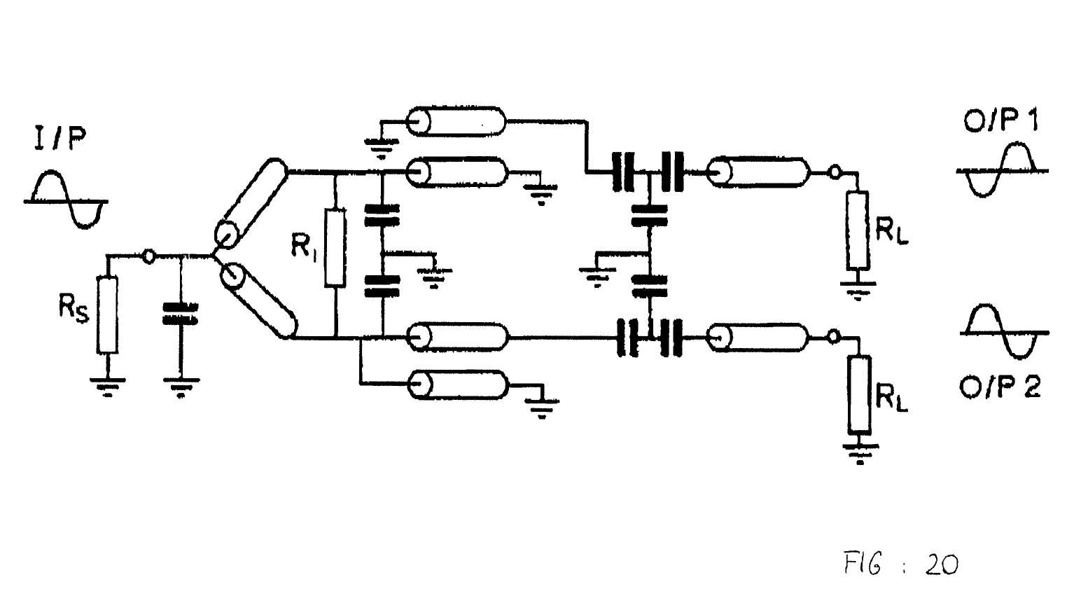

FIG. 21. The coupled lines are terminate using either short circuits or open circuits.

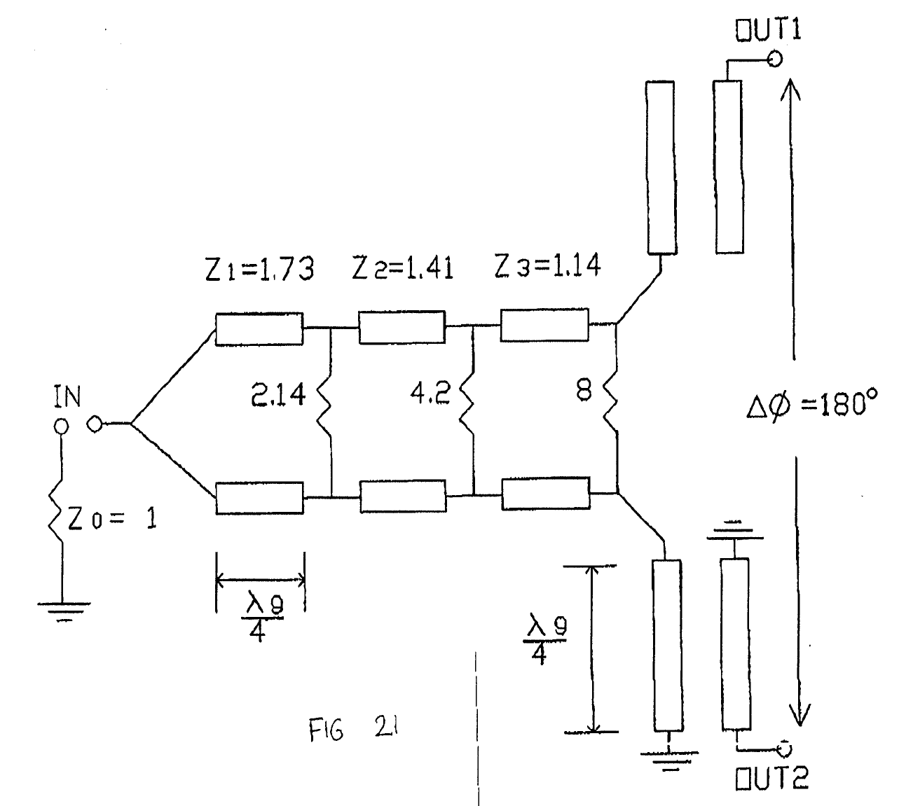

FIG. 22. Quadrature coupler balun.

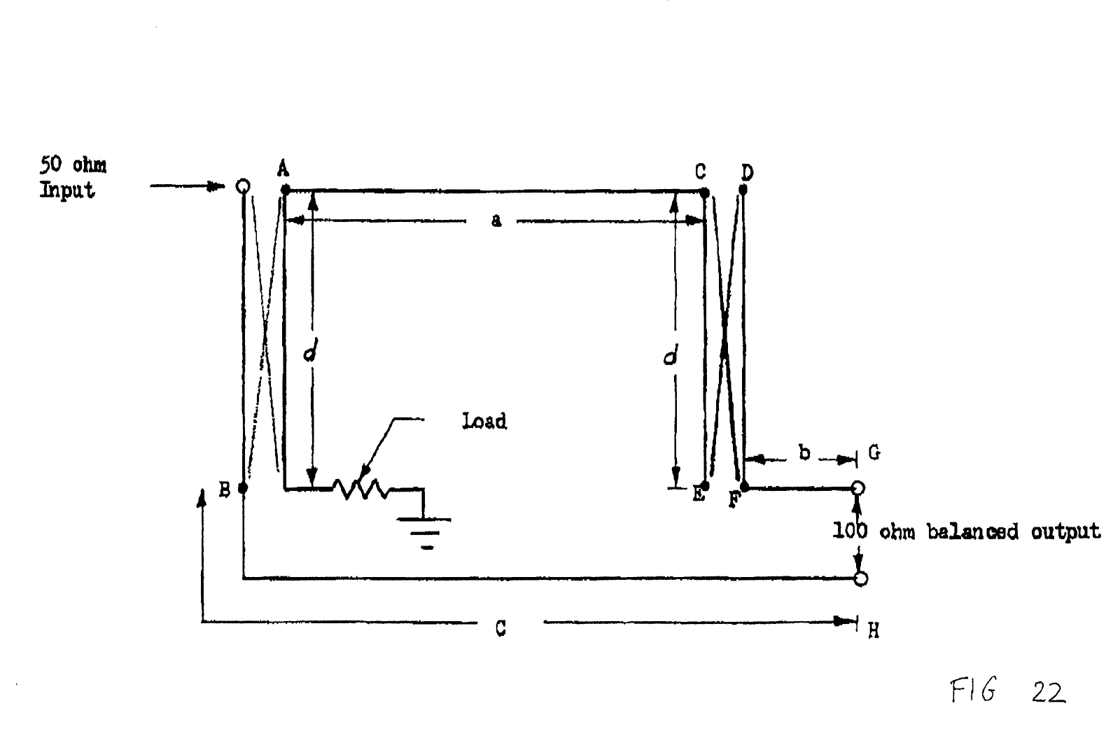

### DETAILED DESCRIPTION

I Introduction

This works describes the design methodology of a broadband, high frequent differential coupler. The output signal of this differential coupler is proportional to the difference of 2 input ports, i.e. proportional to the differential signal of the 2 inputs. This signal is made using a hybrid structure. The overall performance of this differential coupler and the hybrid structure is characterized by the differential coupling factor and by the common mode rejection ratio. A pair of broadband impedances are used to scale the 2 incoming signals with 2 complex coefficients. A symmetric structure of two identical broadband directional couplers and a symmetric power combiner are used afterwards to obtain the differential signal. The high bandwidth of both the terminations, the directional couplers and the power combiner make it possible to obtain a differential coupling factor and a common mode rejection ratio which is frequency insensitive over several decades. Measurements demonstrate a differential coupler with a bandwidth of more than 3 decades.

Difference with existing solutions include the following:

1. A differential coupler tolerates a coupling factor which differs from 3 dB. This gives an additional degree of freedom since the coupling factor has an impact on the bandwidth of the couplers. Broadband couplers with a large coupling factor put more stringent demands on the technology used.

2. The design is fully symmetrical with respect to the 2 input signals and 2 broadband impedances. This makes it possible to rely on the broadband characteristics of the impedances to obtain a good common mode reject ratio. This is in contrast with most baluns found in the literature.

3. Terminating the isolated port of the coupler with a short or an open puts an additional constraint on the power splitter/combiner. Reference [J. Rogers, B. Bhatia, “A 6 to 20 GHz Planar Balun Using a Wilkinson Divider and Lange Couplers”, 1991 MTT-S International Microwave Symposium Digest 91.2, pp. 865-868.] uses Lange couplers with the isolated ports terminated using a short and an open. This puts the constraint on the divider: its 2 output ports must be isolated. Such a divider—a Wilkinson divider in [J. Rogers, B. Bhatia, “A 6 to 20 GHz Planar Balun Using a Wilkinson Divider and Lange Couplers”, 1991 MTT-S International Microwave Symposium Digest 91.2, pp. 865-868.]—puts a constraint on the bandwidth. The presented design makes use of couplers with matched isolated ports. This makes its possible to use a—broadband—resistive power combiner.

Section II provides a more detailed description and analysis of the hybrid structure. Section IV shows measurement results of such structures build using discrete components. These measurement results show that good performance can be obtain over wide frequency rang.

The invented apparatus can comprise at least two differential couplers. Said couplers are characterized by the input-output relationship between their ports. The broadband couplers used throughout the invention have two pairs of ports, the ports within each of said pairs are explicitly physically connected, while the pairs itself are only connected via electromagnetic coupling. More in particular said broadband coupler are designed such that a first port of a first pair is substantially electromagnetically coupled to a first port of the second pair and only partly (due to design imperfections) to the second port of said second pair. On the otherhand said second port of said first pair is substantially electromagnetically coupled to said second port of said second pair and only minor to the other port. In the description the ports of said first pair are denoted first and second port, and the second pair comprises of a third and fourth port of said coupler, said first port being mainly coupled electromagnetically to said fourth port, said second port mainly coupled electromagneticaly with said third port. Said first and second port are physically connected, said third and fourth port are physically connected, said first and second port are not directly physically to said third and fourth port.

It is an aspect of the invention that the signal coupled from said first port, functioning as input port of said coupler, to said fourth port, is absorbed.

II Description and Analysis

A. The elements of the hybrid

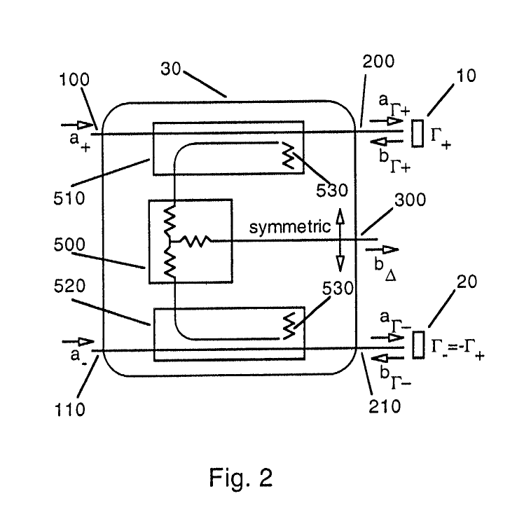

A schematic view of the hybrid structure is shown in FIG. 2. It consists out of a symmetric network—i.e. the 2 directional couplers and the power combiner—and 2 anti-symmetric impedances. Microwave bridges can be used instead of directional couplers.

1. Anti-symmetric impedances

The 2 anti-symmetric impedances satisfy

(f)=Γ₊(f)=−Γ₋(f) (1)

at all considered frequencies. It can be seen as a pair of impedances which are anti-symmetric with respect to the Smith chart. An imbalance will be denoted by such that

f

Γ_{Δ}

$${( 2 ) \\}_{+} = Γ + {Γ}_{Δ} \\ {R}_{\_} = - Γ + {Γ}_{Δ} .$$

Several broadband solutions can be found for the anti-symmetric impedances. Examples are

a short in combination with an open circuit ().

Γ=1

2 resistive impedances satisfy where represents the characteristic impedance used.

₋=Z₀²/Z

Z₀

all pairs of impedances satisfying (1) which are both delayed with identical delay lines with a characteristic impedance and a delay

Z₀

τ

₋(f)e^{-jγ(f)τ}=−Γ₊(f)e^{-jγ(f)} (3)

If is a complex valued function, then lossy delay lines are involved.

γ(f)

2. The directional couplers (or microwave bridges)

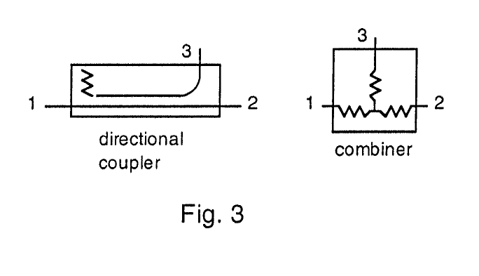

Both the directional couplers/microwave bridges and the power combiners are characterized using 3-by-3 matrices. The port numbering can be seen in FIG. 3. The couplers of the positive and negative signal path are symbolized using S-matrices and respectively. The ideal case assumes that both couplers are identical. This motivates why the analysis is carried out using the common mode and the differential S-parameters

[S^{D}^{₊}]

[S^{D}^{₋}]

$$( 4 ) \\ [ {S}^{D} ] = \frac{1}{2} ( [ {S}^{{D}_{+}} ] + [ {S}^{{D}_{-}} ] )$$

$$( 5 ) \\ [ {S}^{{D}_{Δ}} ] = \frac{1}{2} ( [ {S}^{{D}_{+}} ] - [ {S}^{{D}_{-}} ] )$$

B. Circuit Analysis

A full blown sensitivity analysis results in very complex equations which give very little insight into the design problem of the hybrid structure. This is why the analysis is split into several separate sensitivity analyses.

1. Basic analysis

The basic operation of the hybrid structure can easily be understood when assuming ideal directional couplers and power combiners. The waves and first travel through the 2 identical couplers. Then they are reflected onto the asymmetrical impedances such that and . Assuming ideal couplers with an infinite directivity implies that the output of the directive couplers equals and . Summing these two signals using the power combiner results in an output signal which equals

a₊

a₋

b_{Γ}_{₊}=ΓS₁₂^{D}a₊

b_{Γ}_{₋}=−ΓS₁₂^{D}a₋

S₃₁^{D}ΓS₁₂^{D}a₊

−S₃₁^{D}ΓS₁₂^{D}a₋

b_{Δ}=S₃₁^{C}S₃₁^{D}ΓS₁₂^{D}(a₊−a) (6)

2. Finite directivity of the couplers

The finite directivity of the couplers implies that a part of the incoming energy will be transformed into a common mode signal. This implies that

b_{Δ}=S₃₁^{C}S₃₁^{D}Γ₊S₁₂^{D}(a₊−a₋)+S₃₁^{C}S₂₃^{D}(a₊+a₋) (7)

Hence the common mode rejection ratio

$$( 8 )$$

$$CMMR = \frac{\vert {S}_{31}^{D} Γ + {S}_{12}^{D} \vert}{\vert {S}_{23}^{D} \vert}$$

will heavily depend on the directivity of the coupler. Note that the CMRR is not proportional to the coupling factor of the directive coupler. The fact that and often have the same frequency behaviour implies that it is possible to obtain excellent CMRR over a wider frequency band.

|S₃₁^{D}|

|S₂₃^{D}|

3. Influence of circuit imbalances

An asymmetry in the directional couplers and the power combiner reduces the CMRR. A first order perturbation analysis immediately shows that

b_{Δ}≅S₃₁^{C}S₃₁^{D}Γ₊S₁₂^{D}(a₊−a₋)+(S₃₁^{C}S₃₁^{D}Γ₊S₁₂^{D}^{_{Δ}}+S₃₁^{C}S₃₁^{D}^{_{Δ}}Γ₊S₁₂^{D})(a₊+a₋)+S₃₁^{C}^{_{Δ}}S₃₁^{D}Γ₊S₁₂^{D}(a₊+a₋) (9).

Imbalances of the asymmetric impedance, generate similar results

_{Δ}≅S₃₁^{C}S₃₁^{D}S₁₂^{D}(Γ(a₊−a₋)+Γ_{Δ}(a₊+a₋)) (10)

These results imply that the CMRR will be proportional to the relative imbalance of the different components.

$$( 11 )$$

$$CMRR ≅ \frac{\vert {S}_{31}^{D} Γ + {S}_{12}^{D} \vert}{\vert {S}_{23}^{D} \vert} + \frac{\vert {S}_{12}^{D} \vert}{\vert {S}_{12}^{{D}_{Δ}} \vert} + \frac{\vert {S}_{31}^{D} \vert}{\vert {S}_{31}^{{D}_{Δ}} \vert} + \frac{\vert {S}_{31}^{C} \vert}{\vert {S}_{31}^{{C}_{Δ}} \vert}$$

4. Isolation of the power combiner

An ideal power combiner isolates the different inputs. A Wilkinson power combiner is a possible realization of such combiner. The main advantage of this approach is that the matching of the output of the directional coupler () is not critical.

|S₃₃^{D}|

A resistive power combiner can be made over a high bandwidth. It does not provide any isolation between the different ports. Hence, the output of the directional coupler must be matched in order to reduce the cross-talk from one coupler to the other. This is why a directional coupler is used whose isolated port is terminated using a resistor.

C. Extension to the hybrid structure

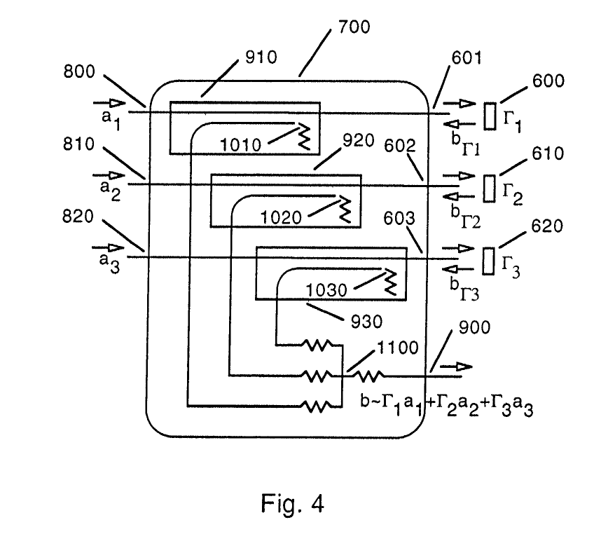

The hybrid structure can easily be extended towards multiple input—multiple output systems where the output signals are proportional to a linear combination of the input signals (FIG. 4). Every input signal is first weighted with a value which is determined by the reflecting impedance. All these scaled inputs are summed afterwards and multiplied with a common value—the transfer function from the reflecting impedance towards the output—to produce the output signal. The fact that broadband resistors, open and short circuits can be constructed in practice, makes it possible to obtain any arbitrary real scaling between −1 and 1 over a wide frequency range.

Γᵢ

III Practical Realization

A wide range of possible hardware realizations are possible:

The directional couplers can be made using coupled transmission lines in various configurations (strip-line, waveguide, coplanar waveguide . . . ) [R. Levy, “General Synthesis of Asymmetric Multi-Element Coupled Transmission-Line Directional Couplers”, IEEE Trans. on Microwave Theory and Techniques, July 1963, pp. 226-237.], [G. Matthaei, L. Young, E. M. T. Jones, “Microwave Filters, Impedance-Matching Networks, and Coupling Structures”, Artech House Books, Dedham, Mass., 1980.]. They can also be replaced by microwave bridges [B. S. Donecker, J. K. Botka, Hewlett Packard Co. (US), U.S. Pat. No. 4,588,970, “Three section termination for an R.F. triaxial directional bridge”.] which can be seen as the high frequent equivalent of a Wheatstone bridge.

Various types of power combiners can be used. Examples are resistive power combiner, Wilkinson power splitter.

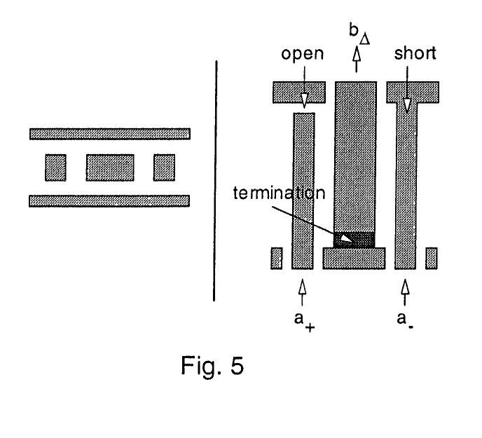

The directional couplers and the power combiner can even be combined into 1 microwave device which consists out of 3 coupled lines. FIG. 5 shows a possible configuration of such setup using coupled thick rectangular bars. The left bar and the centre bar is the first coupler, while the right bar and the centre bar is the second coupler. Combining the power is done at the level of the electrical fields in the centre. The setup of 3 coupled lines requires, however, that the coupling between the left and the right bar is negligible. This is a feasible requirement when working with coupled thick rectangular bars [G. Matthaei, L. Young, E. M. T. Jones, “Microwave Filters, Impedance-Matching Networks, and Coupling Structures”, Artech House Books, Dedham, Mass., 1980.].

IV Measurement Results

Two experimental setups are made in order to demonstrate the hybrid structure. The first setup uses microwave bridges of the HP8515A test set. These bridge operate in the 10 MHz-26.5 GHz frequency range. A second setup uses directional couplers of the HP8517B test set. These are build to operate in the 45 MHz-50 GHz frequency range.

A. Hybrid using microwave bridge up to 26.5 GHz.

The setup was build using standard 3.5 mm technology components:

A HP11667B resistive power splitter which is used as power combiner

A standard short circuit

An open ended rigid coaxial line

2 broadband microwave bridges [B. S. Donecker, J. K. Botka, Hewlett Packard Co. (US), U.S. Pat. No. 4,588,970, “Three section termination for an R.F. triaxial directional bridge”.] coming from an HP8515A S-parameter test set. These bridges make use of a distributed load to obtain broadband characteristics.

All measurements are performed using calibrated network analysers. The measurements up to 300 MHz are performed using a HP8753C. The measurements in the range from 300 MHz up to 26.5 GHz are obtained using a HP8510C.

1. The Microwave bridge

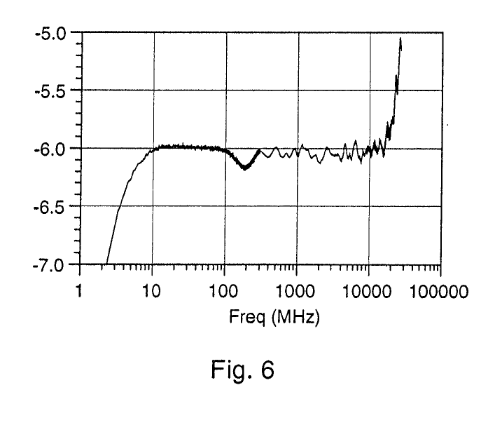

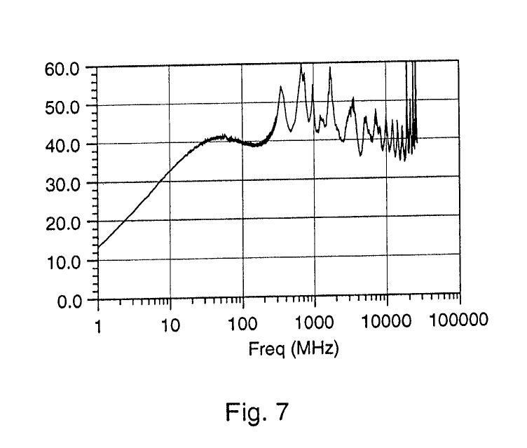

FIGS. 6 and 7 show the coupling factor and the directivity of the microwave bridges used. Both the coupling factor and the insertion loss equal 6 dB over the frequency range of 10 MHz up to 26.5 GHz. The directivity is better than 30 dB in this frequency range.

2. The anti-symmetric impedances

An open and a short circuit are used as anti-symmetric impedances. The open circuit has been realized using an open-ended rigid coax. The length of this rigid coax is adapted such that the open circuit is at the same electronic length than the transmission line in front of the short circuit. The reflection factors of the short and the open are not perfectly anti-symmetrical at higher frequencies. This imbalance comes from the experimental nature of the setup and can be reduced in practice.

3. The differential hybrid structure

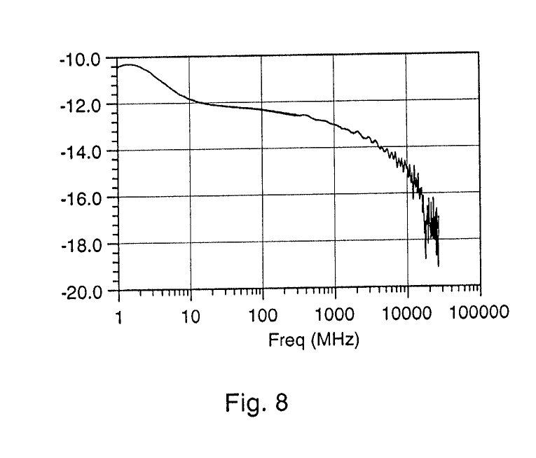

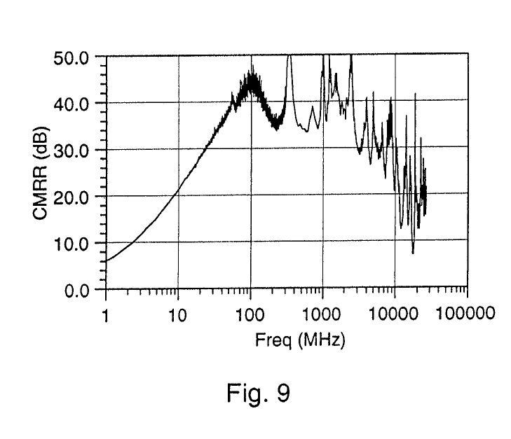

FIGS. 8 and 9 show the coupling factor of the hybrid. It can be seen that the coupling factor is about 12 dB from 10 MHz up to 10 GHz. The CMRR is better than 20 dB in this frequency range. Note that the CMRR is better than 30 dB in the 25 MHz-3 GHz range. Hence, this differential hybrid operates over a frequency range of 3 decades.

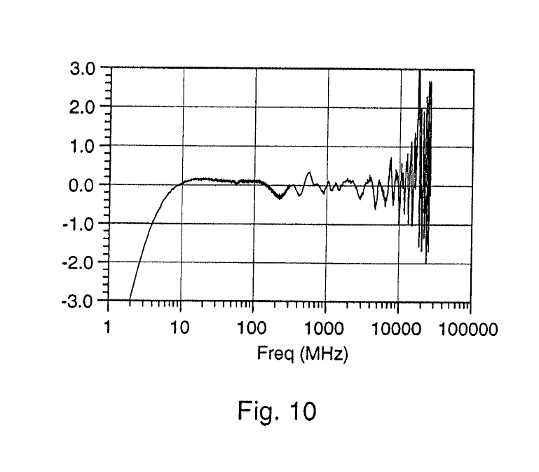

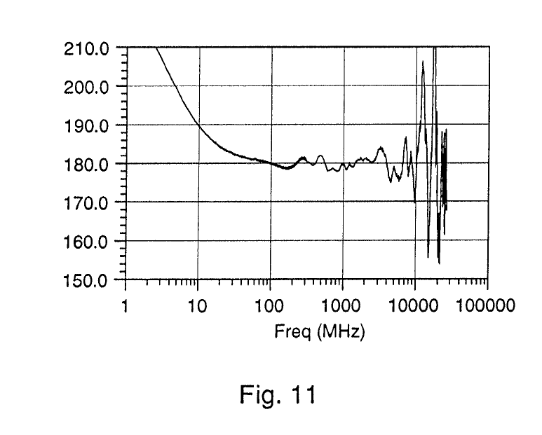

FIGS. 10 and 11 show the relative amplitude and phase characteristic between the signal path of and towards the output. The degradation of the CMRR at higher frequencies is not introduced by the directivity of the couplers, but by the imperfections of the open and short terminations.

B. Hybrid using directional coupler up to 50 GHz.

The setup was build using standard 2.4 mm technology components:

A HP11667C resistive power splitter which is used as power combiner

A standard short circuit

A standard open circuit

2 broadband directional couplers coming from an HP8517B S-parameter test set.

All measurements are performed using a HP8510C calibrated network analysers from 45 MHz up to 50 GHz

1. The directional couplers

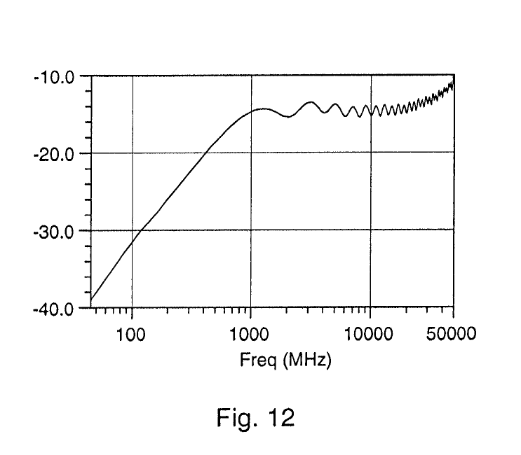

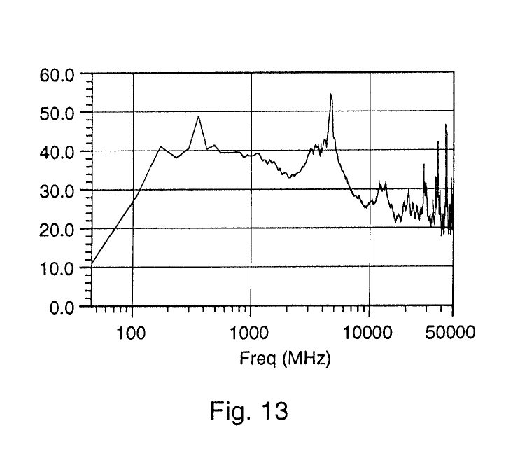

The coupling factor and the directivity of the 50 GHz directional couplers are shown in FIGS. 12 and 13. These strip-line couplers have a small coupling factor below 500 MHz. An excellent directivity (better than 25 dB) is observed between 100 MHz and 15 GHz. This directivity decreases above 10 GHz.

2. The differential hybrid.

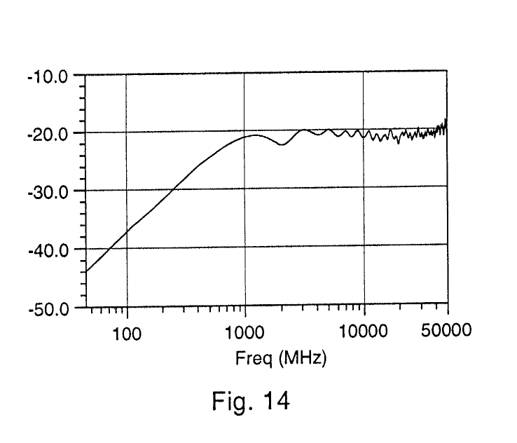

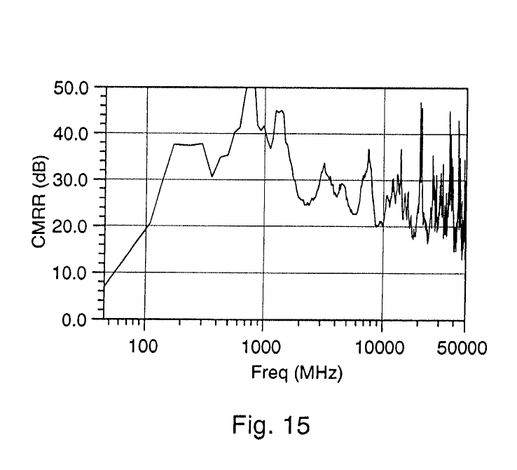

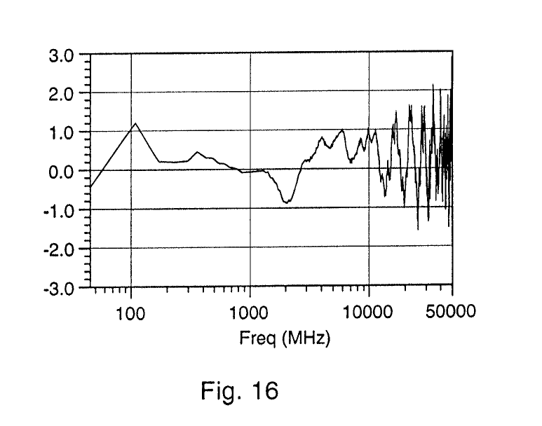

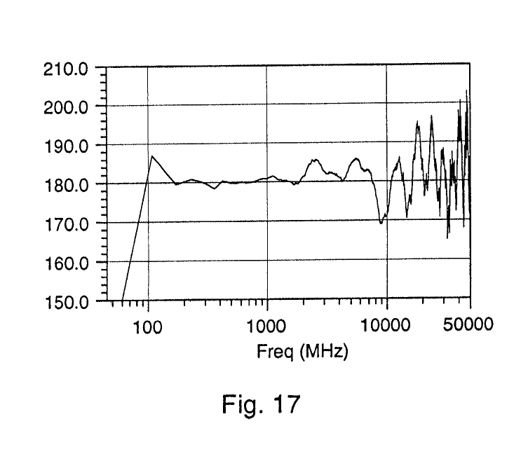

FIGS. 14 and 15 show the coupling factor of the hybrid. It can be seen that the coupling factor is about 21 dB from 500 MHz up to 50 GHz. The CMRR is better than 13 dB in this frequency range. The CMRR is better than 20 dB in the 100 MHz-17.5 GHz range. This is a frequency range of more than 2 decades. FIGS. 16 and 17 show the relative amplitude and phase characteristic between the signal path of and towards the output. The degradation of the CMRR at higher frequencies comes from the reduction of the directivity of the couplers.

V Conclusions

This work describes a broadband differential coupler based on a hybrid microwave structure. The latter is build using broadband microwave circuits and relies on symmetry properties. These 2 aspects make it possible to obtain good performances over several decades in frequency. A sensitivity analysis shows that following properties are of importance for the performance:

the directivity of the directional couplers must be high. This puts a constraint on the technology used for the realization of the couplers.

the symmetry of the hybrid structure.

the ability to make broadband impedance which are anti-symmetric on the Smith chart.

Measurements on setups constructed using discrete components show that a frequency range of 3 decades is feasible and that signals up to 50 GHz can be handled.

The components used within the hybrid apparatus can be characterized by specifying their coupling factor and/or its directivity. With normally operative is meant in one embodiment that a coupling factor above 6 dB within a frequency range or above a maximum frequency. With normally operative is meant in one embodiment that a coupling factor above 12 dB within a frequency range or above a maximum frequency. Alternatively normally operation of such components can mean having a directivity better than 20. Alternatively normally operation of such components can mean having a directivity better than 30 dB). The function of the hybrid apparatus itself can be characterized by its common mode rejection ratio. With normally operative is meant throughout the invention having a common mode rejection ratio above 20 dB within a frequency range or above a maximum frequency. With normally operative is meant throughout the invention having a common mode rejection ratio above 13 dB within a frequency range or above a maximum frequency.

1. An apparatus for determining a differential signal from two input signals, said apparatus comprising:
a first impedance, having a first reflection factor;
a second impedance, having a second reflection factor, said second reflection factor being minus said first reflection factor;
a 5-port circuit having at least a first port receiving a first input signal;
a second port receiving a second input signal;
a third port connected to said first impedance, said third port reflecting a first reflected signal;
a fourth port connected to said second impedance, said fourth port reflecting a second reflected signal; and
a fifth port delivering said differential signal, being a combination of said first reflected and said second reflected signal.

2. The apparatus recited in 1, wherein said 5-port circuit is symmetric with respect to said input signals and said two impedances.

3. The apparatus recited in 1, wherein said 5-port circuit comprises components being still normally operating for signals having frequencies above 1 Ghz.

4. The apparatus recited in 1, wherein said 5-port circuit comprises components being still normally operating for signals having frequencies above 10 Ghz.

5. The apparatus recited in 1, wherein said 5-port circuit comprises components being still normally operating for signals having frequencies above 20 Ghz.

6. The apparatus recited in 1, wherein said 5-port circuit comprises components being normally operating for signals having a frequency spectrum of at least two decades.

7. The apparatus recited in 1, wherein said 5-port circuit comprises components being normally operating for signals having a frequency spectrum of at least three decades.

8. The apparatus recited in 1, wherein said 5-port circuit comprises components being at least normally operating for signals with a frequency spectrum between 10 MHz-20 GHz.

9. The apparatus recited in 1, wherein said 5-port circuit comprises components being at least normally operating for signals with a frequency spectrum between 10 MHz-1 GHz.

10. The apparatus recited in 1, wherein said 5-port circuit comprises components being at least normally operating for signals with a frequency spectrum between 500 MHz-15 GHz.

11. The apparatus recited in 1, wherein
said 5-port circuit comprises reciprocal, loss less, matched networks; and
a power combiner, connecting said networks.

12. The apparatus recited in 11, wherein said 5-port circuit further comprises absorbers.

13. The apparatus recited in 11, wherein said matched networks comprise differential couplers.

14. The apparatus recited in 11, wherein said matched networks comprise microwave bridges.

15. An apparatus for determining a differential signal of two input signals, comprising:
a first directional coupler having:
at least a first port, receiving a first input signal,
at least a second port, receiving a first reflected signal,
at least a third port, transmitting at least a signal being proportional with said first reflected signal;
a second directional coupler having
a first port, receiving a second input signal;
at least a second port, receiving a second reflected signal;
at least a third port, transmitting at least a signal being proportional with said second reflected signal;
a first impedance with a first reflection factor, being connected to said first directional coupler;
a second impedance, being connected to said second directional coupler, and having a second reflection factor being minus said first reflection factor; and
a power combiner, being connected to said third ports of said directional couplers and delivering said differential signal.

16. The apparatus recited in 15, wherein said second ports are physically connected to said first ports.

17. The apparatus recited in 15, wherein said third ports are only electromagnetically connected to said second ports.

18. The apparatus recited in 15, wherein said impedances are connected to said second ports of said differential couplers.

19. The apparatus recited in 15, wherein said directional couplers have a fourth port connected with an absorber, dissipating a substantial part of the part of said input signals, being coupled to said fourth port.

20. The apparatus recited in 15, wherein said directional couplers are substantially identical.

21. The apparatus recited in 15, wherein said power combiner, is a broad band component, with a frequency range of at least two decades.

22. The apparatus recited in 15, wherein said differential couplers are normally still operating for signals having frequencies above 1 Ghz.

23. The apparatus recited in 15, wherein said differential couplers are normally still operating for signals having frequencies above 10 Ghz.

24. The apparatus recited in 15, wherein said differential couplers are normally still operating for signals having frequencies above 20 Ghz.

25. The apparatus recited in 15, wherein said differential couplers are normally operating for signals having a frequency spectrum of at least two decades.

26. The apparatus recited in 15, wherein said differential couplers are normally operating for signals having a frequency spectrum of at least three decades.

27. The apparatus recited in 15, wherein said differential couplers are at least normally operating for signals with a frequency spectrum between 10 MHz-20 GHz.

28. The apparatus recited in 15, wherein said differential couplers are normally at least operating for signals with a frequency spectrum between 10 MHz-1 GHz.

29. The apparatus recited in 15, wherein said differential couplers are normally at least operating for signals with a frequency spectrum between 500 MHz-15 GHz.

30. An apparatus for determining linear combinations of a plurality of input signals, said apparatus comprising:
a plurality of impedances, each having a characteristic reflection factor; and
a multi-port circuit having
a first plurality of ports, receiving said input signals,
a second plurality of ports, connected each to one of said plurality of impedances,
at least one output port, delivering a linear combination of said input signals in accordance with said reflection factors.

31. The apparatus recited in 30, wherein said multi-port circuit further comprise:
a plurality of reciprocal networks;
a plurality of absorbers, each connected to one of said differential couplers; and
at least one power combiner, connected to at least two of said differential couplers.

32. The apparatus recited in 30, wherein said networks are differential couplers.

33. The apparatus recited in 30, wherein said networks are microwave bridges.

34. A method for determining a differential signal from a first and a second signal, said method comprising the steps of:
capturing said first and said second signal;
constructing a reflected first signal, proportional with said first signal with a first reflecting device with a first substantially frequency independent reflection characteristic.
constructing a reflected second signal proportional with said second signal with a second reflecting device with a second substantially frequency independent reflection characteristic;
constructing a third signal, being proportional with said reflected first signal, via electromagnetic coupling;
constructing a fourth signal, being proportional with said reflected second signal, via electromagnetic coupling; and
determining said differential signal by summing said third and fourth signal.

35. The method recited in 34, further comprising the step of absorbing signals being electromagnetically coupled with said first and said second signal.

36. The method recited in 34, wherein said second substantially frequency independent reflection characteristic is minus said first substantially independent reflection characteristic.

37. A method for determining linear combinations of a plurality of signal, said method comprising the steps of:
capturing said plurality of signals;
constructing for each of said plurality of signals a reflected signal, being proportional with said signal, with a reflecting device, with a substantially frequency independent reflection characteristic.
constructing for each of said signals, a coupled signal, being proportional with said signals reflected signal, via electromagnetic coupling; and
constructing each of said linear combinations, by coupled signals.

38. An apparatus for determining a differential signal of two input signals, comprising at least one differential coupler with an input port receiving one of said input signals, wherein the port of said coupler being substantially electromagnetically coupled to said input port being connected to an absorber.

39. An apparatus for determining a differential signal of two input signals, comprising at least one differential coupler with an input port receiving one of said input signals, wherein the port of said coupler being physically coupled to said input port being connected to either a open circuit or a short circuit.

40. An apparatus for determining a differential signal of two input signals, comprising at least two differential couplers with each an input port receiving one of said input signals, wherein the port of said couplers being physically coupled to said input port being connected to a open circuit for one of said couplers and to a short circuit for the other coupler.

41. An apparatus for determining a linear combinations of signals, comprising at least one differential coupler with an input port receiving one of said signals, wherein the port of said coupler being substantially electromagnetically coupled to said input port being connected to an absorber.
